(19) United States
(12) Patent Application Publication
(10) Pub. No.: US 2020/0012045 A1
(43) Pub. Date: Jan. 9, 2020

(54) WAVEGUIDE BENDS WITH MODE-CONFINING STRUCTURES

(71) Applicant: GLOBALFOUNDRIES Inc., Grand Cayman (KY)

(72) Inventors: Yusheng Bian, Ballston Lake, NY (US); Ajey Poovannummoottil Jacob, Watervliet, NY (US)

(21) Appl. No.: 16/026,596

(22) Filed: Jul. 3, 2018

(51) Int. Cl. G02B 6/125; G02B 6/122; G02B 6/136

(52) U.S. Cl. CPC G02B 6/125; G02B 2006/12061; G02B 6/136; G02B 6/1228

(57) ABSTRACT

Waveguide bends and methods of fabricating waveguide bends. A first waveguide bend is contiguous with a waveguide. A second waveguide bend is spaced from a surface at an inner radius of the first waveguide bend by a gap. The second waveguide bend may have a substantially concentric arrangement with the first waveguide bend.

### BACKGROUND

The present invention relates to photonics chips and, more specifically, to waveguide bends and methods of fabricating waveguide bends.

Photonic chips are capable of being used in many applications and many systems including, but not limited to, data communication systems and data computation systems. A photonic chip integrates optical components, such as waveguides, and electronic components, such as field-effect transistors, into a unified platform. Layout area, cost, and operational overhead, among other factors, may be reduced by integrating both types of components on a single photonics chip.

On-chip communication and sensing may rely on transferring optical signals through waveguides on the photonics chip to other optical components. Optical signals propagate as electromagnetic waves within waveguides using a number of different modes characterized by different properties. The transverse electric (TE) mode is dependent upon transverse electric waves in which the electric field vector is oriented perpendicular to the direction of propagation. The transverse magnetic (TM) mode is dependent upon transverse magnetic waves in which the magnetic field vector is oriented perpendicular to the direction of propagation.

Straight waveguides and waveguide bends, as well as other optical components, may have cores that are fabricated from silicon nitride or single-crystal silicon. For transverse electric mode, a waveguide or waveguide bend with a silicon nitride core may have a considerably lower effective index and a significantly weaker field confinement than a waveguide with a single-crystal silicon core. As a result, a portion of the mode field may be pulled outside of the silicon nitride core as optical signals propagate through a waveguide bend, which may lead to a higher bending loss in comparison with a waveguide bend of equal bending radius with a single-crystal silicon core. To compensate for the higher bending loss, a waveguide bend with a silicon nitride core may be provided with a larger radius of curvature than a waveguide bend with a single-crystal silicon core, which increases the footprint of waveguide bends with a silicon nitride core.

Improved waveguide bends and methods of fabricating waveguide bends characterized by reduced bending loss are needed.

### SUMMARY

In an embodiment of the invention, a structure includes a waveguide, a first waveguide bend that is contiguous with the waveguide, and a second waveguide bend spaced from a surface at an inner radius of the first waveguide bend by a gap. The second waveguide bend may have a substantially concentric arrangement with the first waveguide bend.

In an embodiment of the invention, a method includes forming a waveguide and a first waveguide bend that is contiguous with the waveguide, and forming a second waveguide bend that is spaced from a surface at an inner radius of the first waveguide bend by a gap. The second waveguide bend and the first waveguide bend may have a substantially concentric arrangement.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a top view of a photonics chip at a fabrication stage of a processing method in accordance with embodiments of the invention.

FIG. 1A is a diagrammatic view of a portion of the photonics chip of FIG. 1.

FIG. 2 is a cross-sectional view of the photonics chip taken generally along line 2-2 in FIG. 1.

FIG. 2A is a cross-sectional view of the photonics chip at a fabrication stage subsequent to FIG. 2.

FIG. 3 is a top view similar to FIG. 1 of a photonics chip in accordance with alternative embodiments of the invention.

FIGS. 4-7 are top views similar to FIG. 1 of waveguide arrangements for a photonics chip in accordance with alternative embodiments of the invention.

FIGS. 8-10 are cross-sectional views similar to FIG. 2A of waveguide arrangements for a photonics chip in accordance with alternative embodiments of the invention.

### DETAILED DESCRIPTION

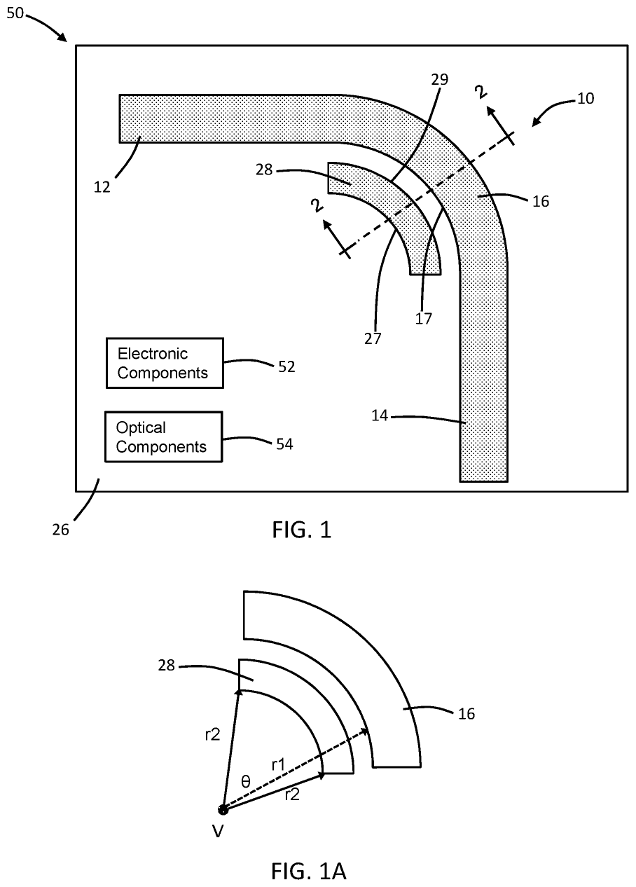

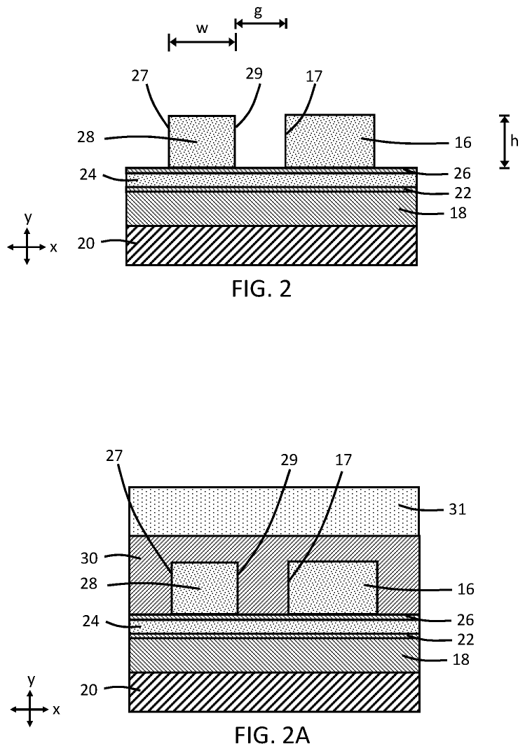

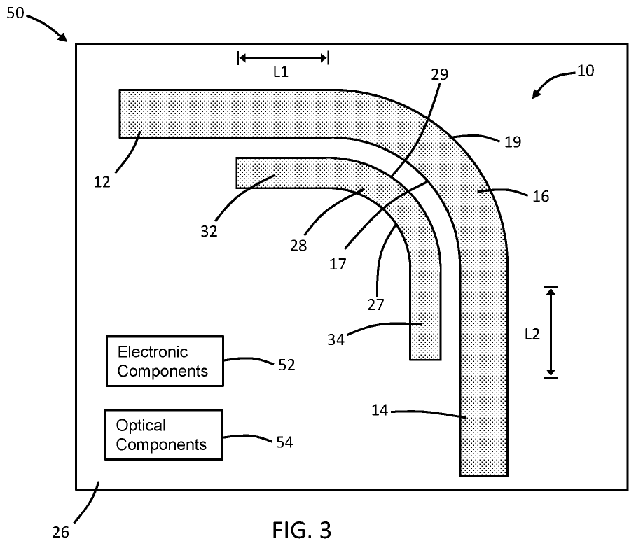

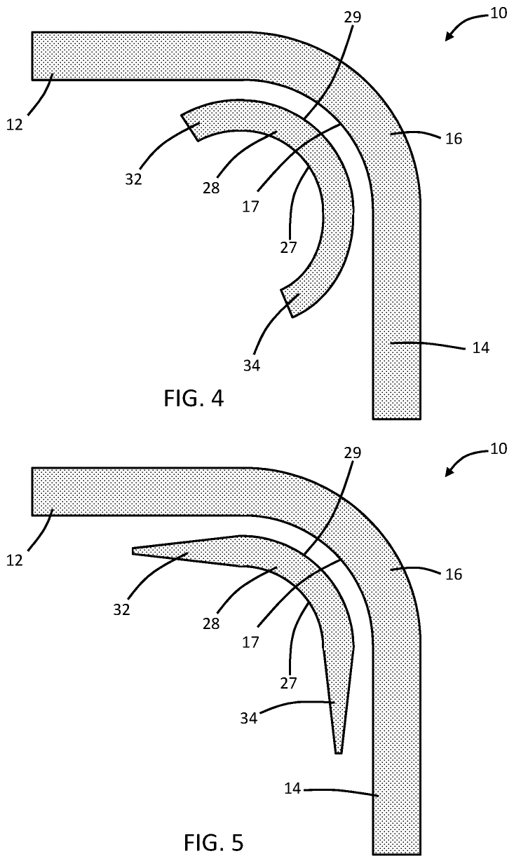

With reference to FIGS. 1, 1A, 2 and in accordance with embodiments of the invention, a structure 10 includes a waveguide 12, a waveguide 14, and a waveguide bend 16 that are arranged over a buried oxide (BOX) layer 18 of a silicon-on-insulator (SOI) substrate and dielectric layers 22, 24, 26 are arranged in a multilayer stack on a top surface of the BOX layer 18. The structure 10 may be located in an area of the SOI substrate in which the single-crystal silicon of the device layer (not shown) has been removed. The waveguide bend 16 has one end that is contiguous with the waveguide 12 and an opposite end that is contiguous with the waveguide 14 such that the waveguide bend 16 connects the waveguide 12 with the waveguide 14. The waveguide bend 16 functions to change the direction of the propagation of optical signals propagating through the structure 10 from, for example, an initial direction within waveguide 12 to a different direction within waveguide 14. The waveguide bend 16 may have an inner radius, r1, that may be measured from a vertex, V, relative to a curved inner surface 17, and may be a sector of an annulus that also includes a curved outer surface 19 having an outer radius that is greater than the inner radius, r1. The waveguide bend 16 may curve in an arc having a central angle equal to 90°, although other central angles and arc lengths are contemplated.

The BOX layer 18 may be composed of an electrical insulator, such as silicon dioxide (e.g., SiO₂), and is located over a handle wafer 20 of the SOI substrate. The dielectric layer 22 and the dielectric layer 26 may be composed of a dielectric material, such as silicon dioxide (SiO₂), deposited by atomic layer deposition (ALD) or chemical vapor deposition (CVD). The dielectric layer 24 may be composed of a dielectric material, such as silicon nitride (Si₃N₄), deposited by atomic layer deposition or chemical vapor deposition. The BOX layer 18 and dielectric layers 22, 24, 26 may operate as a lower cladding providing confinement for the structure 10.

The structure 10 further includes a waveguide bend 28 that is also arranged in a vertical direction over the BOX layer 18 and dielectric layers 22, 24, 26, and that may be arranged in a lateral direction within a plane containing the waveguide 12, waveguide 14, and waveguide bend 16. The waveguide bend 28 is disconnected from the waveguide 12, waveguide 14, and waveguide bend 16, and has a non-contacting relationship with the waveguide 12, waveguide 14, and waveguide bend 16. In the latter regard, the waveguide bend 28 has an inner surface 27 and an outer surface 29 that is separated from the inner surface 17 of the waveguide bend 16 by a space or gap, g, as a result of having a radius of curvature that is less than the radius of curvature of the waveguide bend 16. The waveguide bend 28 is arranged in its entirety inside of the inner surface 17 of the waveguide bend 16.

The waveguide bend 28 is arranged on the inner surface side of the waveguide bend 16 defined by the inner radius, r1, of the waveguide bend. The waveguide bend 28 may have an inner radius, r2, that may be measured as a distance from the vertex, V, relative to the curved inner surface 27, and an outer radius measured as a distance between the vertex, V, and the curved outer surface 29 that is greater than the inner radius, r2. The waveguide bend 28 may have a constant width, w, over its curved length such that the outer radius is equal to the sum of the inner radius, r2, and the width, w. Both the inner radius and the outer radius of the waveguide bend 28 are smaller than the inner radius, r1, of the waveguide bend 16.

In an embodiment, the waveguide bend 28 has an arc length at its inner surface 27 and/or outer surface 29 that is concentric or substantially concentric with the arc length of the waveguide bend 16 at its inner surface 17, and the waveguide bend 28 has a central angle that is equal, or substantially equal, to the central angle of the waveguide bend 16. The waveguide bend 28 may have an arc length at its inner surface 27 and/or outer surface 29 that is shorter than the arc length of the waveguide bend 16 at its inner surface 17. The waveguide bend 28 may curve in an arc with a central angle equal to 90°, although other central angles are contemplated by the embodiments of the invention.

The shape of the waveguide bend 28 may be characteristic of a sector of an annulus in which the arc lengths of the waveguide bend 28 at its inner and outer radii are arcs representing part of the circumference of respective circles. Alternatively, the waveguide bend 28 may be shaped according to another type of curve, such as complex curves that are described by an equation or formula such as a sine function, a cosine function, a spline function, an Euler spiral function, etc. that provide adiabatic bends. In an embodiment, the curvature of the waveguide bend 28 is equal to the curvature of the waveguide bend 16. In an alternative embodiment, the waveguide bend 28 has a curvature that differs from the curvature of the waveguide bend 16.

The waveguide 12, waveguide 14, and waveguide bend 16 may be composed of a dielectric material, such as silicon nitride (Si₃N₄), deposited by chemical vapor deposition and patterned from a layer of their constituent dielectric material with a lithography and etching process. In an embodiment, the waveguide bend 28 is composed of the same dielectric material as the waveguide 12, waveguide 14, and waveguide bend 16. In an embodiment, the waveguide 12, waveguide 14, waveguide bend 16, and waveguide bend 28 may be concurrently patterned using the same lithography and etching process from the same layer of dielectric material such that the waveguide 12, waveguide 14, waveguide bend 16, and waveguide bend 28 all have the same thickness in the vertical direction (i.e., y-direction).

With reference to FIG. 2A in which like reference numerals refer to like features in FIG. 2 and at a subsequent fabrication stage of the processing method, the structure 10 may further include a dielectric layer 30 that is formed over the structure 10, and that fills the gaps between the waveguide 12, waveguide 14, waveguide bend 16, and waveguide bend 28. The dielectric layer 30 is composed of a dielectric material having a different composition than the dielectric material constituting the waveguide 12, waveguide 14, waveguide bend 16, and waveguide bend 28. The dielectric layer 30 may be composed of a dielectric material, such as silicon dioxide (SiO₂), deposited by chemical vapor deposition using ozone (O₂) and tetraethylorthosilicate (TEOS) as reactants and planarized with chemical-mechanical polishing (CMP).

A back-end-of-line stack, generally indicated by reference numeral 31, may be formed over the dielectric layer 30. The back-end-of-line stack 31 may include one or more dielectric layers composed of a low-k dielectric material or an ultra-low-k (ULK) dielectric material and metallization composed of, for example, copper or cobalt that is arranged in the one or more dielectric layers.

The structure 10, in any of its embodiments described herein, may be integrated into a photonics chip 50 that includes other types of electronic components 52 and optical components 54. For example, the photonics chip 50 may integrate one or more photodetectors representing optical components 54 that receive optical signals carried by the structure 10 and convert those optical signals into electrical signals that may be processed by the electronic components. The electronic components 52 may include field-effect transistors that are fabricated by CMOS front-end-of-line processes using the device layer of the SOI substrate.

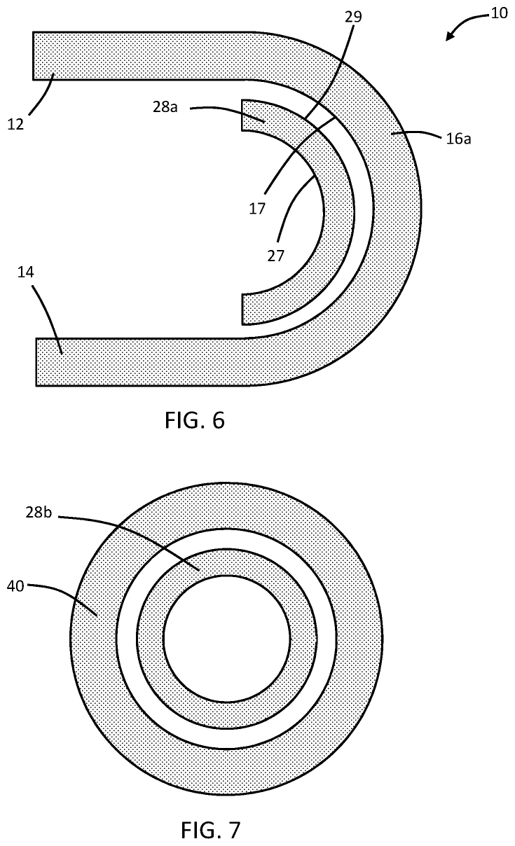

With reference to FIG. 3 in which like reference numerals refer to like features in FIG. 1 and in accordance with alternative embodiments of the invention, the waveguide bend 28 of the structure 10 may be modified to add a waveguide section 32 arranged at an end of the waveguide bend 28 and a waveguide section 34 that is arranged at an opposite end of the waveguide bend 28. The waveguide sections 32, 34 are contiguous with the opposite ends of the waveguide bend 28. The waveguide sections 32, 34 may be formed when the waveguide bend 28 is formed by patterning a layer of dielectric material (e.g., silicon nitride) and, in an embodiment, are concurrently formed with the waveguide 12, waveguide 14, waveguide bend 16, and waveguide bend 28. The waveguide sections 32, 34 are arranged in a vertical direction over the BOX layer 18 and dielectric layers 22, 24, 26.

The waveguide section 32 has a length, L1, and may be straight or linear without bending or curving such that the waveguide section 32 is aligned substantially parallel to the waveguide 12. The waveguide section 34 has a length, L2, and may be straight or linear without bending or curving such that the waveguide section 34 is aligned substantially parallel to the waveguide 14. Each of the waveguide sections 32, 34 may have a constant width over their respective lengths. The gap between the waveguide bend 28 and the waveguide bend 16 may be maintained between the waveguide section 32 and the waveguide 12 and also maintained between the waveguide section 34 and the waveguide 14. In the representative embodiment, the waveguide sections 32, 34 have a uniform width along their respective lengths, which may be equal to the width of the waveguide bend 28. In an embodiment, the curvature of the waveguide bend 28 is equal to the curvature of the waveguide bend 16. In an alternative embodiment, the waveguide bend 28 has a curvature that differs from the curvature of the waveguide bend 16.

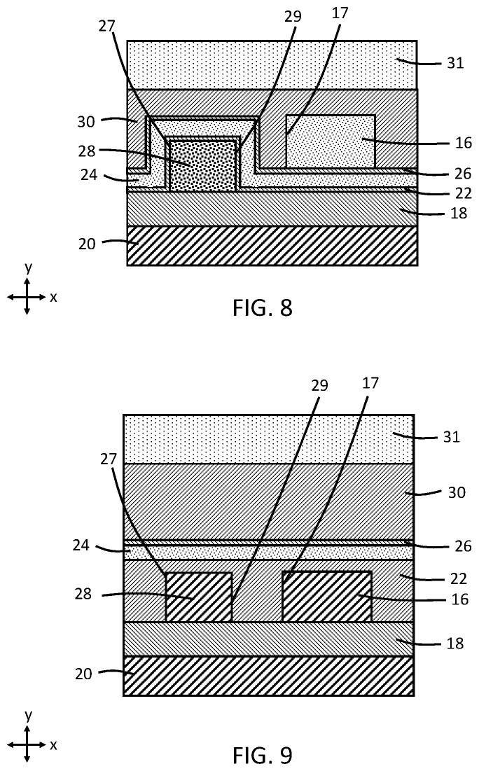

With reference to FIG. 4 in which like reference numerals refer to like features in FIG. 2 and in accordance with alternative embodiments of the invention, one or both of the waveguide sections 32, 34 may be curved along at least a portion of their respective lengths instead of being linear and straight. In the representative embodiment, the waveguide section 32 has a curvature that differs from the curvature of the waveguide section 34. In an alternative embodiment, the curvature of the waveguide section 32 is equal to the curvature of the waveguide section 34.

With reference to FIG. 5 in which like reference numerals refer to like features in FIG. 2 and in accordance with alternative embodiments of the invention, one or both of the waveguide sections 32, 34 may be tapered along at least a portion of their respective lengths and extend to terminating tips instead of having a uniform width along their respective lengths. In an embodiment, the width of the waveguide sections 32, 34 decrease with increasing distance from the waveguide bend 28 with the waveguide sections 32, 34 having the largest respective width at their intersection with the waveguide bend 28. In an embodiment, the tapered waveguide sections 32, 34 is also curved as shown in FIG. 4 to provide a combination of tapering and curvature. In an embodiment, the curvature of the waveguide bend 28 is equal to the curvature of the waveguide bend 16. In an alternative embodiment, the waveguide bend 28 has a curvature that differs from the curvature of the waveguide bend 16.

With reference to FIG. 6 in which like reference numerals refer to like features in FIG. 1 and in accordance with alternative embodiments of the invention, a waveguide bend 16a and a waveguide bend 28a may have arc lengths and a value of their central angle that provide changes in direction for light propagation greater than 90°. For example, the change in direction may be 180°. The waveguide bend 28a may be considered to include a plurality of individual sections, each like the waveguide bend 28, that are cascaded to assist with confinement in the waveguide bend 16a. For example, a pair of the waveguide bends 28 having equal radii of curvature and a 90° central angle may be butted and cascaded to provide a waveguide bend 28a providing a 180° change in direction for the propagation of optical signals in the waveguides 12, 14. In an embodiment, the curvature of the waveguide bend 28a is equal to the curvature of the waveguide bend 16a. In an alternative embodiment, the waveguide bend 28a has a curvature that differs from the curvature of the waveguide bend 16a.

With reference to FIG. 7 in which like reference numerals refer to like features in FIG. 1 and in accordance with alternative embodiments of the invention, the utilization of the waveguide bend 28 may be extended to other types of curved structures, such as ring resonators and arrayed-waveguide gratings. For example, a waveguide bend 28b may be a ring that is substantially concentric with a structure 40 that is also ring-shaped. The radius of curvature of the waveguide bend 28b is less than the radius of curvature of the structure 40, which may function as a ring resonator. The waveguide bend 28b and the structure 40 may have other shapes, such as elliptical shapes, that are non-circular. In addition, the gap between the waveguide bend 28b and the structure 40 may vary with location about the perimeter of the waveguide bend 28b.

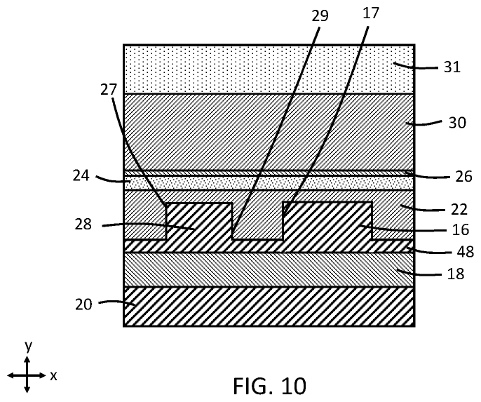

With reference to FIG. 8 in which like reference numerals refer to like features in FIG. 2A and in accordance with alternative embodiments of the invention, the composition of the waveguide bend 28 may be altered such that the waveguide bend 28 is composed of a different material than the waveguide bend 16. In that regard, the waveguide bend 36 may be formed from a layer of the different material that is deposited and patterned using a lithography and etching process that is separate and distinct from the lithography and etching process used to pattern the material constituting the waveguide 12, waveguide 14, and waveguide bend 16. In an embodiment, the waveguide bend 36 is composed of polysilicon, and the waveguide 12, waveguide 14, and waveguide bend 16 are composed of silicon nitride. The waveguide bend 36 is arranged in a vertical direction over the BOX layer 18, and the dielectric layers 22, 24, 26 may extend across and over the waveguide bend 36, instead of being arranged beneath the waveguide bend 36. The structure 10 that includes the waveguide bend 36 that is composed of a different material than the waveguide 12, waveguide 14, and waveguide bend 16 may be modified to have a construction as shown in any of FIGS. 3-7.

With reference to FIG. 9 in which like reference numerals refer to like features in FIG. 2A and in accordance with alternative embodiments of the invention, the waveguide 12, waveguide 14, waveguide bend 16, and waveguide bend 28 of the structure 10 may be composed of a single-crystal semiconductor material. In an embodiment, the single-crystal semiconductor material is single-crystal silicon from the device layer of the SOI substrate that is patterned to form the structure 10, and the waveguide 12, waveguide 14, waveguide bend 16, and waveguide bend 28 are arranged in a vertical direction over the BOX layer 18. The dielectric layers 22, 24, 26, the dielectric layer 30, and the back-end-of-line stack 31 are arranged over the structure 10 with the dielectric layer 22 providing gap filling. The structure 10 composed of single-crystal semiconductor material may be modified to have a construction as shown in any of FIGS. 3-7.

With reference to FIG. 10 in which like reference numerals refer to like features in FIG. 2A and in accordance with alternative embodiments of the invention, the waveguide 12, waveguide 14, waveguide bend 16, and waveguide bend 28 of the structure may be composed of the single-crystal semiconductor material. In an embodiment, the single-crystal semiconductor material is single-crystal silicon from the device layer of the SOI substrate that is patterned to form the structure 10, and the waveguide 12, waveguide 14, waveguide bend 16, and waveguide bend 28 are arranged in a vertical direction over the BOX layer 18. The etching process of the patterning is controlled such that a layer 48 of partially-etched single-crystal semiconductor material of the device layer is arranged in the gap between the waveguide bend 16 and the waveguide bend 28, as well as over other areas surrounding the structure 10. The layer 48 has a thickness in the vertical direction (i.e., y-direction) that remains as a result of the partial etching, and that is less than the original thickness of the device layer. The dielectric layers 22, 24, 26, the dielectric layer 30, and the back-end-of-line stack 31 are arranged over the waveguide 12, waveguide 14, waveguide bend 16, and waveguide bend 28 with the dielectric layer 22 providing a gap filling function. The structure 10 composed of partially-etched single-crystal semiconductor material may be modified to have a construction as shown in any of FIGS. 3-7.

The embodiments of the waveguide bend 28 described herein may improve confinement of optical signals of the transverse electric mode in the core of the waveguide bend 16 and, thereby, may reduce the bending loss in the waveguide bend 16 attributable to, for example, radiation loss and mode-mismatching loss in comparison with an arrangement in which the waveguide bend 28 is absent. Coupling between the waveguide bend 16 and the waveguide bend 28 may improve mode confinement of the optical signals, which may lead to reduced radiation loss through the bends. In addition, the waveguide bend 28 may assist in confining the mode field into the core of the waveguide bend 16, which may lead to decreased mode-mismatching loss.

References herein to terms such as “vertical”, “horizontal”, “lateral”, etc. are made by way of example, and not by way of limitation, to establish a frame of reference. Terms such as “horizontal” and “lateral” refer to a direction in a plane parallel to a top surface of a semiconductor substrate, regardless of its actual three-dimensional spatial orientation. Terms such as “vertical” and “normal” refer to a direction perpendicular to the “horizontal” direction. Terms such as “above” and “below” indicate positioning of elements or structures relative to each other and/or to the top surface of the semiconductor substrate as opposed to relative elevation.

A feature “connected” or “coupled” to or with another element may be directly connected or coupled to the other element or, instead, one or more intervening elements may be present. A feature may be “directly connected” or “directly coupled” to another element if intervening elements are absent. A feature may be “indirectly connected” or “indirectly coupled” to another element if at least one intervening element is present.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A structure comprising:
a substrate;
a dielectric cladding layer over the substrate;
a waveguide on the dielectric cladding layer;
a first waveguide bend on the dielectric cladding layer, the first waveguide bend contiguous with the waveguide, and the first waveguide bend having a surface arranged in a first arc defining an inner radius; and
a second waveguide bend on the dielectric cladding layer, the second waveguide bend having a surface arranged in a second arc spaced from the surface at the inner radius of the first waveguide bend by a first gap, and the second waveguide bend having a first end and a second end,
wherein the second waveguide bend curves in the second arc from the first end of the second waveguide bend to the second end of the second waveguide bend, the surface of the second waveguide bend is arranged in its entirety inside of the surface arranged in the first arc at the inner radius of the first waveguide bend, and the surface of the second waveguide bend is concentric with the surface at the inner radius of the first waveguide bend.

2. The structure of claim 1 wherein the waveguide, the first waveguide bend, and the second waveguide bend are coplanar, and the waveguide, the first waveguide bend, and the second waveguide bend are comprised of silicon nitride.

3. The structure of claim 1 wherein the first waveguide bend is comprised of silicon nitride and the second waveguide bend is comprised of polysilicon.

4. The structure of claim 1 wherein the first waveguide bend and the second waveguide bend are comprised of a single-crystal semiconductor material.

5. The structure of claim 1 wherein the first waveguide bend and the second waveguide bend are comprised of a single-crystal semiconductor material, and a thin layer of the single-crystal semiconductor material connects the first waveguide bend with the second waveguide bend.

6. The structure of claim 1 wherein the first arc has a first central angle, the second arc has a second central angle, and the first central angle is substantially equal to the second central angle.

7. (canceled)

8. The structure of claim 1 further comprising:
a first waveguide section that is contiguous with the first end of the second waveguide bend, the first waveguide section arranged adjacent to the waveguide.

9. The structure of claim 8 wherein the waveguide is lengthwise straight, the first waveguide section is lengthwise straight and aligned substantially parallel with the waveguide, the first waveguide section includes a first terminating tip opposite along the first waveguide section from the first end of the second waveguide bend, and further comprising:
a second waveguide section that is contiguous with the second end of the second waveguide bend,
wherein the second waveguide section is lengthwise straight, and the second waveguide section includes a second terminating tip opposite along the second waveguide section from the second end of the second waveguide bend.

10. The structure of claim 8 wherein the first waveguide section has a length and is spaced from the waveguide by a second gap equal to the first gap along the length.

11. The structure of claim 8 wherein the waveguide is lengthwise straight, and the first waveguide section is lengthwise curved.

12. The structure of claim 8 wherein the first waveguide section has a length and a width that tapers along the length.

13. The structure of claim 1 further comprising:
a third waveguide bend spaced from the first waveguide bend by the first gap and contiguous with the second waveguide bend, the third waveguide bend having a substantially concentric arrangement relative to the first waveguide bend.

14. A method comprising:
forming a waveguide and a first waveguide bend that is contiguous with the waveguide, wherein the waveguide and the first waveguide bend are positioned on a dielectric cladding layer that is located over a substrate, and the first waveguide bend has a surface arranged in a first arc defining an inner radius; and
forming a second waveguide bend positioned on the dielectric cladding layer, the second waveguide bend having a surface arranged in a second arc that is spaced from the surface at the inner radius of the first waveguide bend by a gap,
wherein the second waveguide bend curves in the second arc from a first end of the second waveguide bend to a second end of the second waveguide bend, the second arc is arranged in its entirety inside of the surface arranged in the first arc at the inner radius of the first waveguide bend, and the surface of the second waveguide bend is concentric with the surface of the first waveguide bend.

15. (canceled)

16. The method of claim 14 further comprising:
depositing a layer of silicon nitride; and
patterning the layer of silicon nitride with a lithography and etching process to form the waveguide, the first waveguide bend, and the second waveguide bend.

17. The method of claim 14 further comprising:
patterning a device layer of a silicon-on-insulator wafer with a lithography and etching process to form the waveguide, the first waveguide bend, and the second waveguide bend.

18. The method of claim 14 wherein forming the waveguide and the first waveguide bend that is contiguous with the waveguide comprises:
depositing a layer of silicon nitride; and
patterning the layer of silicon nitride with a first lithography and etching process to form the waveguide and the first waveguide bend.

19. The method of claim 18 wherein forming the second waveguide bend that is spaced from the first waveguide bend by the gap comprises:
depositing a layer of polysilicon; and
patterning the layer of silicon nitride with a second lithography and etching process to form the second waveguide bend.

20. The method of claim 14 further comprising:
forming a waveguide section that is contiguous with the second waveguide bend,
wherein the waveguide section is arranged adjacent to the waveguide.

21. The structure of claim 9 wherein the second waveguide section and the waveguide are separated by a second gap equal to the first gap.

22. The structure of claim 1 wherein the first gap between the surface at the inner radius of the first waveguide bend and the surface of the second waveguide bend is constant.
